(19) United States
(12) Patent Application Publication
(10) Pub. No.: US 2012/0037011 A1
(43) Pub. Date: Feb. 16, 2012

(54) Deep fryer

(75) Inventors: In Won Seo, Chungcheongnam-do (KR); Young Joong Kwon, Seoul (KR)

(73) Assignee: In Won Seo, Chungcheongnam-do (KR)

(21) Appl. No.: 13/265,443

(22) PCT Filed: Jul. 28, 2009
(86) PCT No.: PCT/KR09/04203

§ 371 Date: Oct. 20, 2011

(30) Foreign Application Priority Data
Apr. 21, 2009 (KR) 10-2009-0034577

(51) Int. Cl. A47J 37/12

(52) U.S. Cl. 99/403

(57) ABSTRACT

The present invention relates to a deep fryer for deep flying, and more particularly, to a fryer for frying vegetables or meat such as chicken and the like, which: prevents carbonization occurring when flour, batter or the like, coated on the surface, peels off from the vegetables or meat and is left in high heat conditions such as heated cooking oil for lengthy periods; operates at a relatively low temperature to prevent oxidation of the cooking oil caused by lengthy operation of the deep fryer at high temperatures; and speeds up cooking by providing more heat energy. The deep fryer comprises: electric heater (1); collection container (7) which separates undesirable residue such as flour or batter separated from vegetables, meat and the like in frying pot (2); screw (104) which functions as a blender for mixing oil and water at a certain ratio while transferring the undesirable residue from frying pot (2) to collection container (7); thereby preventing acidification of the cooking oil and enhancing the turbidity thereof.

### TECHNICAL FIELD

In the conventional art, there were problems such as carbonization occurring when flour, batter, and the like, coated on the surface, peels off from a food material such as meat such as chicken, vegetables, and the like, and contacts with a heater and the like that is provided in a lower portion of a frying pot to cause a heat, or affect against the turbidity of cooking oil, or generation of toxic substances such as trans fat and the like occurring when cooking oil is heated near to an ignition point of cooking oil in order to fry processed meat products, and the like.

### BACKGROUND ART

To outperform the problems found in the conventional art, the present invention effectively configures a collection container that is thermally separated from a frying pot containing a direct heat source and contains water with a high specific heat and a high specific gravity compared to cooking oil, and the like, which, instead of separating residue such as batter and the like left after cooking, automatically separates the residue while cooking and circulates cooking oil containing a predetermined ratio of water in a lower portion of the frying pot through a quantitative control, thereby effectively removing residue deposited in the lower portion of the frying pot. Here, a predetermined amount of water is heated on the surface of a heater and turns into high calories of vapor and thereby is scattered over the cooking oil. Accordingly, the present invention may provide the frying pot containing the overall appropriate quantity of heat.

### DISCLOSURE OF INVENTION

### Technical Goals

To achieve the above objectives of the present invention, residue such as bread crumbs, flour, and the like, separated or peeled off from food materials such as vegetables or meat needs to be effectively separated. When processing water of a collection container containing the separated residue, cooking oil needs to be prevented from being mixed with waste water. The quantitative control needs to be performed so that a predetermined amount of water may be vaporized in a frying pot.

### Technical Solutions

According to an aspect of the present invention, there is provided a deep fryer, wherein a high temperature of a frying pot and a collection container containing water are separated from each other and are connected to each other using a pipe, a screw for circulating cooking oil into one direction is installed in the middle of the pipe, residue collected in circulating cooking oil accelerates a contact with water due to stirring operation by the eddy of the screw to thereby separate oil components from the collection container, and a partition wall for preventing the separated residue from flowing again into the frying pot and the like is configured in the collection container, and an electron valve for inflow and cutoff of tap water and a water level sensor for managing a water level, a sensor for measuring a temperature, a control circuit for controlling the speed of the screw, and the like, are configured to generate a predetermined amount of vapor.

### Advantageous Effect

According to the present invention, it is possible to prevent cooking oil from being discolored to be black, and to prevent carbohydrate such as flour and the like from being exposed to a high heat and thereby being transformed to toxic substances such as trans fat. A predetermined amount of vapor contains high calories and thus reduces a cooking time and prevents food materials from being excessively dehydrated. In addition, cooking is quickly performed at a relatively low temperature to thereby significantly decrease the destruction of nutrients. Accordingly, it is possible to use cooking oil for a lengthy period and to perform cooking useful for health.

### BRIEF DESCRIPTION OF DRAWINGS

FIG. 1 is a perspective view to describe the present invention;

FIG. 2 is an interior perspective view of FIG. 1;

FIG. 3 is an interior perspective view illustrating a cut right side of FIG. 1 to describe the present invention;

FIG. 4 is a view to describe the circulation of cooking oil according to the present invention;

FIG. 5 is a view to describe a structure of a nozzle duct for circulating oil inducement and vapor generation;

FIG. 6 is an interior perspective view illustrating the cut front of FIG. 1; and

FIG. 7 is a view to describe a configuration of a screw for circulation.

Explanation of reference numerals used in drawings

| | |
|---|---|
| 1: electric heater (heat source) | 2: frying pot |
| 3: valve for cooking oil discharge | 4: cutoff valve for upper/lower |
| | cooking oil |
| 5, 14: union connectors | |

6: electron valve for water level control (supply)

| | |
|---|---|
| 7: water supply valve | 8: collection container |

9: electron valve for water level control (discharge)

| | |
|---|---|
| 10: discharging hole | |
| 11, 15: water level sensors | 12: cutoff valve for circulating oil |
| 13: circulating oil transfer pipe | 16: air exhauster |
| 17: water level indicator | 101: residue filtering wall |
| 102: screw rotation motor | 104: circulation and stirring screw |

105: nozzle duct for circulating oil inducement and vapor generation
106: indicator for circulating oil migration

| | |
|---|---|
| 107, 109: circulating oil transfer pipe | |
| 110: screw outer wall pipe | 120: support for heater interval |
| | maintain |

121: funnel for circulating oil inducement
122: circulation oil outlet for vapor generation

### BEST MODE FOR CARRYING OUT THE INVENTION

Hereinafter, embodiments of the present invention will be described with reference to the accompanying drawings.

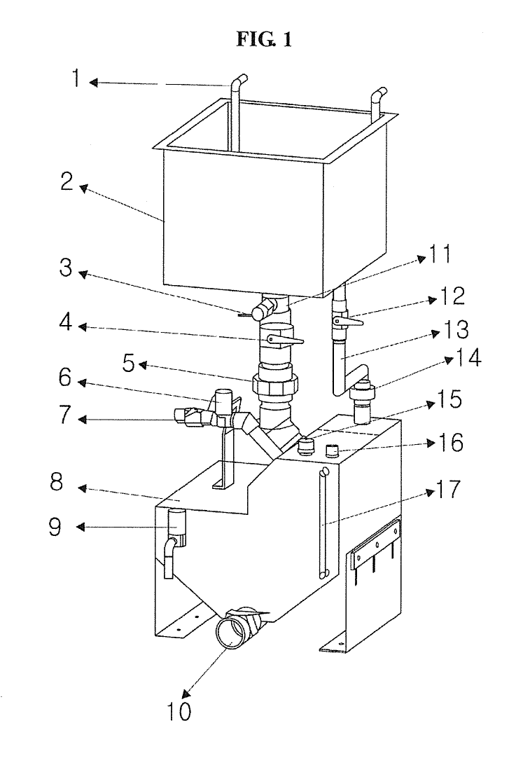

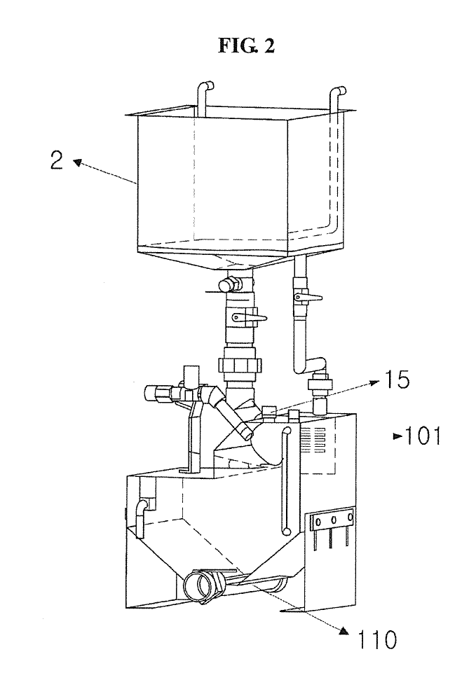

FIG. 1 is a perspective view to describe the present invention, and FIG. 2 is an interior perspective view of FIG. 1. Referring to FIG. 1 and FIG. 2, a frying pot 2 (hereinafter, referred to as a “pot”) for heating cooking oil is positioned in a geographically top portion where the gravity affects. A heater 1 such as an electric heat is installed within the pot 2 at an appropriate height from a lower portion of the pot 2. Water having a relatively great specific gravity compared to cooking oil is filled in a lower portion of the heater 1. A collection container 8 for filtering and sinking residue is positioned below the pot 2 and is connected to the pot 2 using a pipe that is connected between the pot 2 and the collection container 8 using a valve 4, manually opened and closed, and a union connector 5.

In FIG. 1, reference numeral 3 indicates a valve for cooking oil discharge, reference numeral 6 indicates an electron valve for water level control (supply), reference numeral 7 indicates a water supply valve, reference numeral 9 indicates an electron valve for water level control (discharge), reference numeral 10 indicates a discharging hole, reference numerals 11 and 15 indicate water level sensors, reference numeral 13 indicates a circulating oil transfer pipe, reference numeral 14 indicates a union connector, reference numeral 16 indicates an air exhauster, and reference numeral 17 indicates a water level indicator.

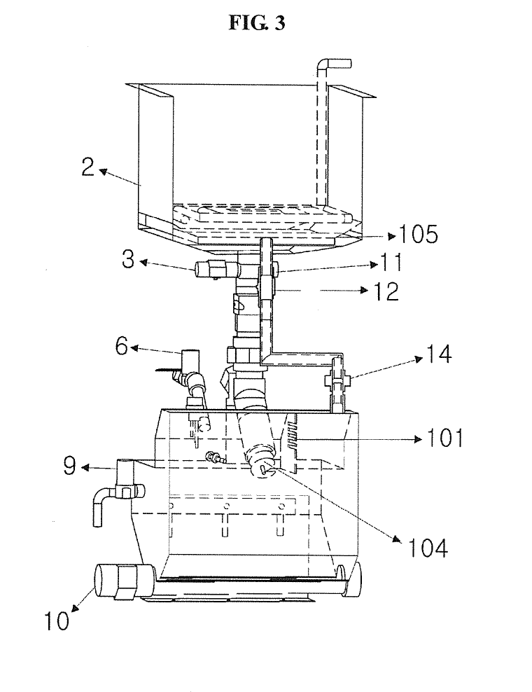

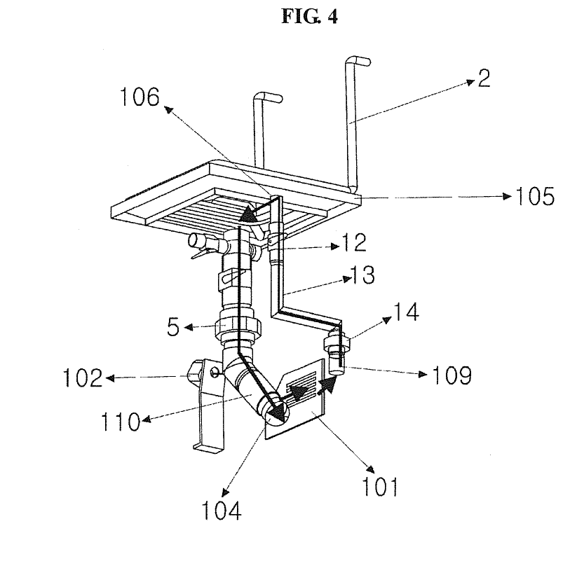

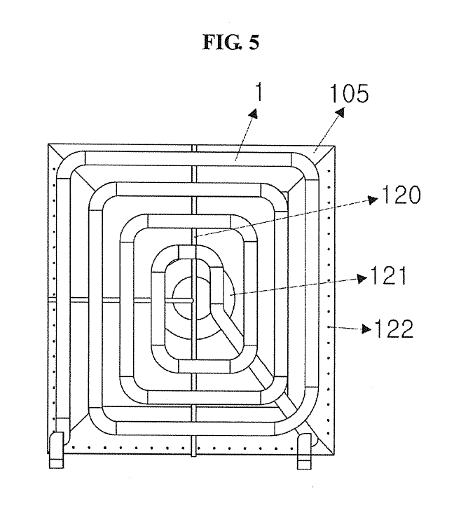

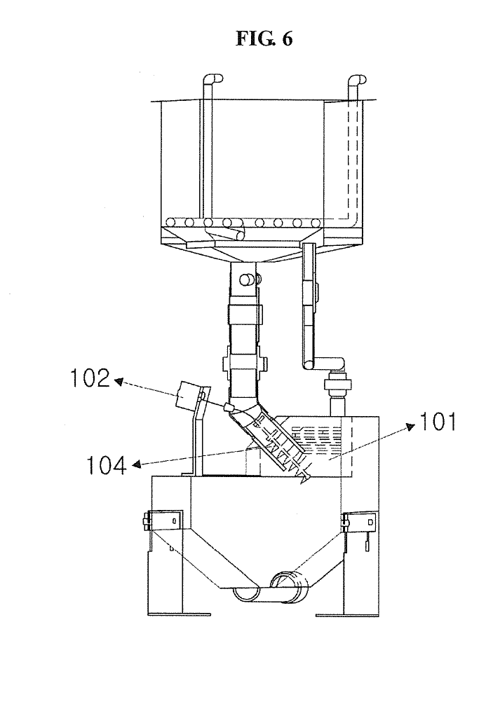

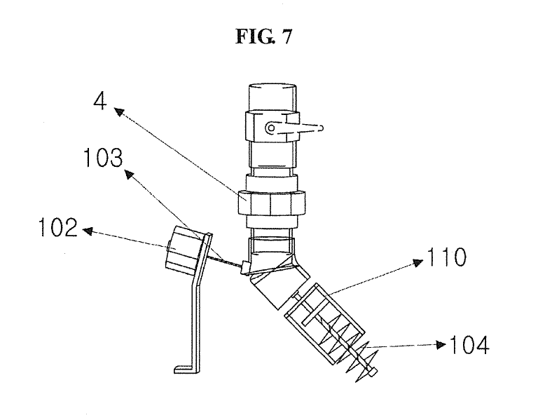

FIG. 3 is an interior perspective view illustrating a cut right side of FIG. 1 to describe the present invention. In FIG. 3, reference numeral 101 indicates a residue filtering wall, and reference numeral 104 indicates a circulation and stirring screw. FIG. 4 is also a view to describe the circulation of cooking oil according to the present invention, FIG. 5 is a view to describe a structure of a nozzle duct for circulating oil inducement and vapor generation, FIG. 6 is an interior perspective view illustrating the cut front of FIG. 1, and FIG. 7 is a view to describe a configuration of a screw for circulation. Here, reference numeral 102 indicates a screw rotation motor, reference numeral 103 indicates a rotation shaft connecting the screw rotation motor 102 and the circulation and stirring screw 104, reference numeral 105 indicates a nozzle duct for circulating oil inducement and vapor generation, reference numeral 106 indicates an indicator to describe circulation, reference numeral 110 indicates a screw outer wall pipe, reference numeral 120 indicates a support for maintaining an interval of the heater 1, reference numeral 121 indicates a funnel for circulating oil inducement, and reference numeral 122 indicates a circulation oil outlet for vapor generation

In the above-noted embodiment, in the case of an operation, the electron valve for water level control (supply) 6 connected in series to the water supply valve 7 may be opened to fill water in the collection container 8 until the water reaches a predetermined level, while monitoring the electronic type water level sensor 15 using an electronic controller (not shown). Here, when cooking oil is filled in the pot 2 positioned above the collection container 8, the cutoff valve for upper/lower cooking oil 4 and the cutoff valve for circulating oil 12 may be in a locked state through a manual manipulation. The air within the collection container 8 may be discharged through the air exhauster 16 while the water is being filled in the collection container 8.

When the water fills in the collection container 8 by a predetermined water level, the electronic controller may output a signal sound indicating that the water is filled in by the predetermined water level and may display, on a display, a message indicating opening of the cutoff valves 4 and 12. In this case, the cutoff valves 4 and 12 may be artificially opened and cooking oil filled in the pot 2 flows down into the collection container 8 along a connection pipe including the valve 4 and the union connector 5. The water and the cooking oil may contact with each other on the water level surface of the collection container 8.

On the contrary, in the case of an operation for discharging water or cooking oil, the electron valve 6 for controlling the water level may be opened by supplying tab water in a state where the cutoff valve 4 is open. When adding water, the contact surface between cooking oil and water may increases whereby the water may push up the cooking oil above the pot 2. Here, a control circuit (not shown) for monitoring the water level sensor 11 may suspend supply of tab water, and may output a sound and display a message. When artificially closing the valves 4 and 12 and discharging water within the collection container 8, the water may be discharged to the outside through the discharging hole 10.

Also, when discharging cooking oil, the cooking oil may be discharged by opening the valve for cooking oil discharge 3. To prevent cooking oil from being mixed with water when discharging the water, water may be filled in to be above the valve 4 at which a separation into an upper portion and a lower portion is enabled, using an aspect that the cooking oil has a relatively low specific gravity compared to the water. Also, the water level sensors 11 and 15 may be configured based on an aspect that general cooking oil has no conductivity and water has conductivity.

In the above-noted embodiment, an operation of performing a frying dish will be described. Cooking oil may be heated by supplying power to the heater 1 until the cooking oil reaches a temperature set in an electronic temperature controller (not shown). Here, when quickly heating cooking oil until the cooking oil reaches a predetermined appropriate temperature, the circulation and stirring screw 104 of FIG. 3 may operate to pull down the cooking oil of the upper portion to the collection container 8, and an end portion of the circulation and stirring screw 104 quickly rotating by the screw rotation motor 102 may contact with a water layer. In this instance, water and cooking oil may be stirred. The pressure within the collection container 8 may increase by an amount of cooking oil pulled down to the collection container 8 from the pot 2 of the upper part. The mixture of water and cooking oil may flow into the pot 2 through the nozzle duct 105 for circulating oil induction and vapor generation, disposed below the pot 2, along the circulating oil transfer pipes 13 and 109 via a slit groove of the residue filtering wall 101 of FIG. 4. A temperature of the mixture is lower than a temperature of cooking oil within the pot 2 and thus, the mixture may flow in the lower portion of the pot 2 without elevating due to convection dynamics and thereby discharge residue such as bread crumbs falling down and the like and may push the residue down into the collection container 8 by the suction force generated by the motion of the circulation and stirring screw 104. A portion of the mixture pushed up due to the pressure of the nozzle duct 105 for circulating oil induction and vapor generation may reach the circulation oil outlet for vapor generation 122 of FIG. 5, which is formed in an upper portion of the nozzle duct 105. Through this, vapor may be heated by the heater 1 positioned in the upper portion and thereby elevates. About 593 calories/g may be required to make water into vapor. In this instance, vapor may absorb a sufficient amount of calories with preventing a temperature of the surface of the heater 1 from excessively increasing and thereby be mixed with cooking oil and elevates. With elevating, the vapor may absorb calories of cooking oil having a high temperature and thereby turn into vapor having a high containing heat. If simply comparing, calories contained in vapor 1g may be at least 1000 folds of calories contained in 1 g of cooking oil.

Accordingly, an appropriate amount of vapor may be generated by controlling the number of rotations of the circulation and stirring screw 104 provided within the collection container 8 to thereby control the pressure within the collection container 8, and by controlling an amount of water discharged via the circulating oil outlet 122 for vapor generation based on the pressure.

Also, hot cooking oil including vapor may cause a great convection to thereby enable very fast heat exchange on the surface of food materials (not shown) to be fried. Due to a specific heat of vapor, containing energy enables the food materials to be quickly fried. Accordingly, even though data may differ based on a containing level of vapor, an amount of time, for example, about 15 minutes generally used to fry chicken at the temperature of 180 degrees may be reduced to be around ten minutes. Here, cooking may proceed at a significantly low temperature in which the temperature of cooking oil is about 150 degrees. As described above, since the temperature of cooking oil is relatively reduced, it is possible to decrease destruction of nutrients contained in food materials and to delay the acidification of cooking oil, and to less discharge unique juicy components contained in the food materials, thereby softening a dish.

In the above-noted embodiment, flour, batter, and the like, coated on food materials (not shown), may be peeled off or be separated from the food materials during is cooking. Here, some peeled off bread crumbs or flour may be afloat on cooking oil while moisture components are being vaporized in the hot cooking oil. When the moisture components are completely vaporized, the bread crumbs or flour may be precipitated and thereby sink down since the bread crumbs or flour has a relatively high density and a high specific gravity compared to the cooking oil. Here, the bread crumbs or flour may be swept over and thereby be moved down to the collection container 8 by the mixture of water and cooking oil circulating in the lower portion of the pot 2. While being stirred with water by means of the circulation and stirring screw 104 that rotates by the screw rotation motor 102, the bread crumbs or flour may discharge cooking oil components contained in the precipitate, and thereby sink down in the water due to a specific gravity difference. As indicated by an arrow indicator of FIG. 4, cooking oil separated from the participate as above may elevate back into the pot 2 whereby the cooking oil may be prevented from being discharged when discharging water via the discharging hole 10 of the collection container 8. The water level may be controlled by opening the electron valve 6 for water level control (supply) to thereby supplement water when a water level is lowered due to the vaporization while continuously repeating the above process, and by opening the electron valve for water level control (discharge) 9 to thereby discharge water when the water level increases to at least a predetermined level due to a great amount of precipitate sunk down in the collection container 8. The water level sensor 15 for sensing the water level includes several steps of water levels and thereby gives hysteresis in order to prevent the above discharge and supply from frequently occurring.

Referring to FIG. 4, the residue filtering wall 101 is provided to prevent precipitated residue from being pushed up again to the circulating oil transfer pipe 109 by convection that is generated by the circulation and stirring screw 104. Only liquid components may get out via slit holes formed in the residue filtering wall 101 and residue may be filtered.

As shown in FIG. 6 and FIG. 7, the circulation and stirring screw 104 installed within the screw outer wall pipe 110 may receive rotary power from the screw rotation motor 102, installed outside the screw outer wall pipe 110, and thereby rotate. To solve a disorder or an insanitation issue occurring due to use of a pump type, the present embodiment connects a rotation shaft of the screw rotation motor 102 and a rotation shaft of the circulation and stirring screw 104 using the rotation shaft 103 such as a coil spring. Accordingly, since rotation is enabled at any angles and floating materials within the deep fryer are separated, the deep fryer may be hygienically safe.

1. A deep fryer comprising:
a collection container being provided in a lower portion of a frying pot for cooking oil, to perform inflow and discharge of tap water using an electron valve and a valve while monitoring a water level sensor using an electronic controller,
wherein residue is deposited and is separated, and thereby is collected in the collection container by enabling a cooking oil layer having a relatively low specific gravity compared to water to remain in an upper portion at all times due to water pressure flowing in from an outside, and by circulating the mixture of cooking oil and water in the lower portion.

2. The deep fryer of claim 1, wherein, in the frying pot, the mixture of cooking oil and water is controlled using a pressure of a screw pump at a lower surface position of a heater whereby water contacting with the surface of the heater is vaporized and high temperature and high calories of vapor is propagated to the cooking oil to thereby increase the overall containing heat.

3. The deep fryer of claim 1, wherein a screw pump is installed in an end of a pipe that connects the frying pot and the collection container in order to effectively transfer the residue deposited in the lower portion of the frying pot, to quickly separate cooking oil from the residue containing the cooking oil, and to thereby deposit the residue into water, mixes water and cooking oil at a predetermined ratio, and controls the height of the mixture of water and the cooking oil to reach the lower portion of the frying pot.

4. The deep fryer of claim 1, wherein when replacing water of the collection container or discharging cooking oil of the frying pot, a water level within the collection container is increased by making tap water flow into the collection container, the water level is controlled using a water pressure and specific gravity difference until cooking oil components completely float on the frying pot whereby cooking oil is prevented from being mixed with waste water when discharging the waste water and water is prevented from being mixed with cooking oil when discharging the cooking oil.

5. The deep fryer of claim 1, wherein when a temperature of water in the collection container significantly increases, cold water is supplied from an outside and an amount of water corresponding to an amount of the supplied cold water is discharged by operating a discharge electron valve through a monitor of the water level sensor whereby a water level is maintained at a predetermined level and the temperature within the frying pot is maintained.

6. The deep fryer of claim 1, wherein a cooking time is reduced at a relatively low temperature by heating vapor together with cooking oil, and by increasing containing calories within the frying pot, and nutrients are prevented from being destroyed by delaying acidification of cooking oil.
